(19) United States
(12) Patent Application Publication
(10) Pub. No.: US 2010/0161538 A1
(43) Pub. Date: Jun. 24, 2010

(54) Device for user input

(76) Inventors: Thomas William Kennedy, JR., Dallas, TX (US); Thomas William Kennedy, SR., Plano, TX (US)

Correspondence Address: Thomas Kennedy, 3324 McKinney Ave., Apt. 716, Dallas, TX, 75204, US

(21) Appl. No.: 12/317,173

(22) Filed: Dec. 22, 2008

(51) Int. Cl. G06N 5/02; G06F 3/041

(52) U.S. Cl. 706/47; 345/173

(57) ABSTRACT

An electronic device receives text inputs. The device predicts the user's intended input by analyzing text previously and subsequently entered. The device compares the previous and subsequent input to the current input to ensure that the inputs are compatible. The device may also be capable of comparing previous input to predict current input. The device also may contain a keyboard designed to minimize user input error. Examples to which this invention applies include predictive text and autocorrect features of word processors and mobile phones.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention Art

The present invention relates generally to input devices and more particularly, to improving user experience and efficiency in using input devices, on electronic devices such as cell phones and computers by way of effective prediction, correction, and/or prevention of user error.

2. Description of the Related Art

The growing popularity of SMS (Short Message Service) or text messaging has resulted in an evolving set of innovations for entering text to be sent. Users of mobile phones typically use the numeric buttons to enter letters. Given that multiple letters are assigned to each button, a user may have to press the same button multiple times to enter the desired letter. To resolve this inefficiency, predictive text schemes have been developed In one scheme, the user only presses one button per letter, and the phone analyzes the sequence of buttons pressed to determine the proper word. However, it is often the case that the sequence of letters pressed results in more than one possible word. In this instance, the user must select the intended word from the set of words that match the sequence. U.S. patent application Ser. No. 10/378,953, sought to reduce the set of words from which the user must choose by assigning “argument” values to previously entered words in the message. By calculating the most prevalent argument values the system could reduce the set of words to those corresponding to that argument. For example, if the most prevalent argument value is “news,” then the set of words that matched the sequence of buttons pressed would be reduced to those words that also related to news.

Other innovations regarding predictive text include a system in which the device takes the buttons already pressed to predict the letters that are needed to complete a word. This method is particularly useful when a full keyboard is used to enter letters. However, if the full keyboard is a virtual keyboard on the screen of a mobile phone, for example, then the space available for each key is reduced and the likelihood of the user pressing an unintended key in increased. In this instance, current technology can correct this mistake by comparing the complete, misspelled word with actual words that closely correspond to the sequence of letters pressed.

### SUMMARY OF INVENTION

The object of this invention is to improve predictive text and autocorrect systems to improve user efficiency and speed. In one embodiment the device considers each word in the message to ensure that the message in compatible with a comprehensible message.

Another object of the invention is to improve user interaction in predictive text. Users are given a choice of words that can be selected based on minimal input, so that keystrokes are reduced and users are more involved in the predictive process. Another object of the present invention is to improve virtual keyboards to minimize user error.

Another object of the invention is to present the user with a non-standard arrangement of keys to improve the efficiency of inputting messages. This may be accomplished by changing the shape of the keys, shape of the keyboard, and/or arrangement of the keys.

### BRIEF DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 depicts a cellular phone with a typical keyboard and display.

FIG. 2 depicts an embodiment of the present invention which demonstrates a virtual keyboard accompanied by several columns of predictive input for user selection.

FIG. 3 depicts an embodiment of the present invention which demonstrates a virtual keyboard accompanied by a single column of predictive input for user selection.

FIG. 4 depicts an embodiment of the present invention which demonstrates a circular keyboard with keys of alternating shapes accompanied by a single row of predictive input for user selection.

FIG. 5 depicts an embodiment of the present invention which demonstrates a virtual keyboard aligned in the fashion of a traditional keyboard but with buttons of alternating shapes accompanied by four columns of predictive input for user selection.

FIG. 6 depicts two sections of two different virtual keyboards wherein in both cases the keys are of alternating, differing shape and wherein two buttons are associated with exemplary areas defining the area wherein pressing will input the letter of that key.

### DETAILED DESCRIPTION OF INVENTION

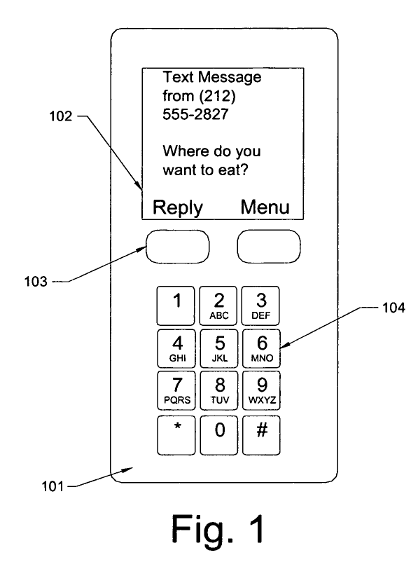

The users of mobile phones and similar devices typically input text by use of standard twelve button keyboard (buttons for 0-9, *, and #) or by way of a full QWERTY keyboard. A typical cellular phone is depicted in FIG. 1 as 101. Cellular phone 101 has a display 102 for displaying text as well as other media. Cellular phone 101 also has a standard twelve button keyboard 104 along with two action keys 103. The buttons numbered two through nine on keyboard 104 can be used to input letters. Each button corresponds to more than one letter, e.g. the “2” button corresponds to letters “A”, “B”, and “C”, as shown in 104. For the user to input the letter “C”, the user must press the “2” button three times in succession. Or, if the user has a predictive text program, the user must only press the button once for each letter, and the device determines a word, or set of words based on the sequence of buttons pressed. If more than one word can be formed from the sequence of buttons pressed, then the user must select the intended word from the list of words matching the sequence. If this set of words is reduced then efficiency of messaging can be increased.

The set of words can be reduced with a system that analyzes the entire message to ensure that the message is compatible with conventional and contemporary language. For example, if a typical user wishes to type the words “CELL PHONE” then he/she will press the following sequence 2-3-5-5 on the keyboard of FIG. 1. This sequence generates two possible words: “CELL” and “BELL”. Next, the user will enter the sequence 7-4-6-6-3, which generates “PHONE” and “SHONE”. In the preferred embodiment, the phone will process these inputs to determine that the only compatible formation of these words.

In certain instances the device will be able to make this determination by simply accessing a language program. For instance, if a user wishes to enter the phrase “I WILL CALL YOU LATER”, the user will enter 2-2-5-5 to enter the word “CALL”. This sequence returns the following possible words: “BALL”, “CALL”, and “BALK”. The language program will be accessed to determine that a verb should follow “WILL”, thereby eliminating “BALL”. The language program will also be accessed to determine that presence of the word “YOU” directly after the verb, indicates that the verb must be transitive, thereby eliminating “BALK” in its most common usage. Thus, the system is able to determine the proper word from a set of three possible words by checking the sequence for its compatibility with English.

It is likely that some users may wish to enter text that is non-compliant with traditional English. In this instance, the user may alter the program such that certain rules are ignored. For example, it is common for some speakers of English to end a sentence in a preposition, although this is considered improper English. For example, a user may wish to enter the phrase: “WHAT IS THAT ABOUT?”. This may confuse the predictive text system operating under an English rules program. In order to prevent this, a user may disable this rule or any other rule that the user finds unhelpful. Similarly, the user may define his/her own rules for the predictive system to take into account. These rules may be based on parameters that the user finds will improve his/her inputting efficiency.

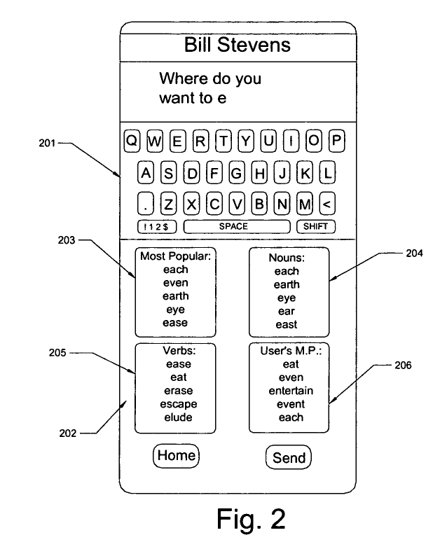

In devices where a virtual, touch-screen QWERTY keyboard is used, T9 type predictive text is not needed. FIG. 2 shows a typical cellular phone with a virtual, touch-screen QWERTY keyboard, labeled 201. In these devices, other predictive text schemes are currently used. For example, current systems can complete longer words by analyzing the first letters of the word entered. For example, if the user enters the letters P-A-T-E, the system will predict that the user is trying to type the word “PATENT”. However, if the user wishes to enter the phrase “PROGRAM FIVE WILL BE ELIMINATED”, the current systems do not effectively predict the word “ELIMINATED”. If the system uses prediction schemes combined with the comparison techniques previously discussed, then it can correctly predict “ELIMINATED.” For example, by accessing the language program, the system will know that when the user has entered the letters E-L-I-M that the word should be “ELIMINATED” instead of “ELIMINATE”, “ELIMINATION”, or “ELIMINATES”, as those words would not make sense in context with the rest of the sentence. Thus, the broad comparison techniques that were previously discussed can be applied to standard QWERTY keyboards as well as standard twelve-button dialpads for phones.

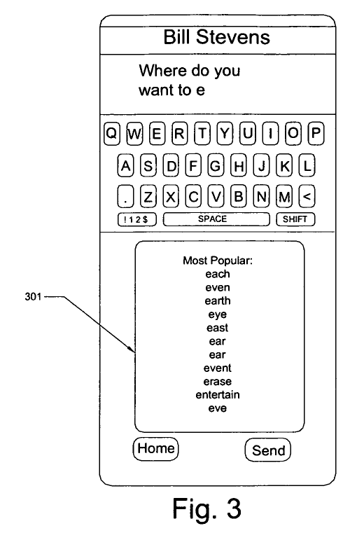

Furthermore, it is possible to improve the efficiency of inputting text by allowing the user to choose from a list of possible words at the earliest possible moment. For example, if a user is using a virtual, touch-screen QWERTY keyboard it a variety of lists of words to be chosen by the user can be supplied based on minimal input from the user. For example, if the user types the letter “E” to begin a word then a list of words beginning with “E” will be displayed on a portion of the screen for selection by the user as depicted in the space labeled 202 in FIG. 2. In FIG. 2, a list of words is displayed for selection by the user. The list is divided into several columns containing words. The first column, 203, contains a list of the overall most popular words starting with the letter “E”. The second column, 204, contains a list of the most popular nouns starting with the letter “E”. The third column, 205, contains a list of the most popular verbs starting with the letter “E”. The fourth column, 206, contains a list of the user's personally most frequently used words starting with the letter “E”. Additional columns can be added to include adverbs, articles, prepositions, etc. Furthermore, the user can adjust the number of columns displayed, adjust the order of the columns displayed, as well as create customized columns for display. For example, the user can create a column to only display words that consist of three letters or less. The content of the columns is adjusted in real time to adapt to the letters inputted by the user. For example, if the user enters “T” and then “O” the lists change to eliminate words that may have started with the letter “T” but do not have “O” as their second letter. Furthermore, a user can select a column to expand so that it contains additional words that take the space of the unexpanded columns as seen in column 301 in FIG. 3.

An additional column can be added to the above described table for a list of words that are most likely to be the user's intended word. This list is generated using rules stored in memory. Examples of these rules include comparison rules for determining words commonly used in combination as well as rules of language, predictive rules, and other rules that could be useful in determining or predicting a user's intended word.

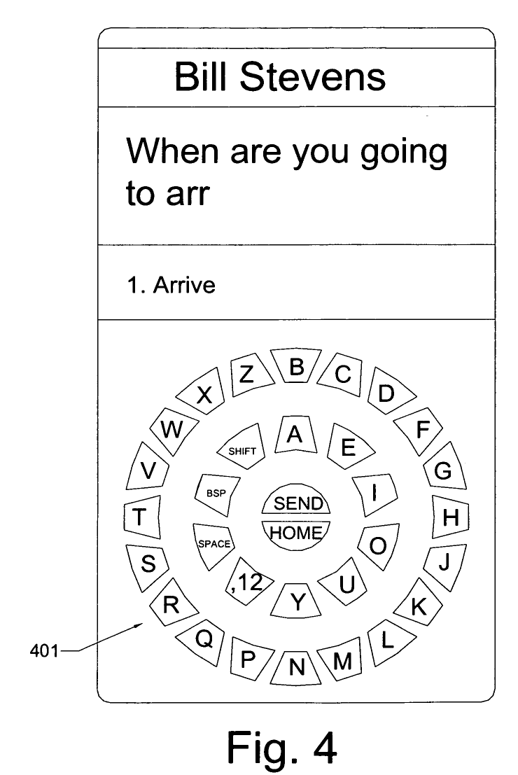

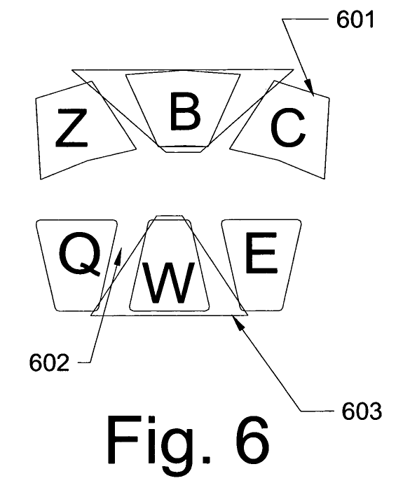

One issue with virtual QWERTY keyboards is a lack of space for to accommodate the keyboard on small devices such as a cellular phone. Given this lack of space it is common that a user mistypes one or more of the intended letters in a word. Current systems can correct these mistakes using predictive text methods. The above described techniques can also be utilized to correct such mistyped letters. Also, QWERTY keyboards can be rearranged to minimize user error in typing letters as well as to maximize efficiency in correcting mistyped words. An example of this is the circular keyboard in FIG. 4. FIG. 4 arranges the full twenty-six letter alphabet into two circles of buttons as seen in 401. The inner circle contains every vowel, “Y,” and some action keys. Furthermore, inside both circles is the “SEND” button and a “HOME” button for exiting the current action. The outer circle contains every remaining consonant. Furthermore, the keys are arranged in an alternating pattern wherein the general shape of the key is wider at the top in one instance and wider at the bottom in the other instance, as seen in 401. This arrangement decreases the mistyped keystrokes because users can focus there touch on the outer part of the circle for letters with a longer arc on the outer part of the circle as in letter 402. Likewise, users can focus there touch on the inner part of the circle for letters with a longer arc on the inner part of the circle as in letter 403. This effect can be increased by increasing the boundaries of the letters beyond their graphically depicted scope to further capitalize on the differences in arc length in the inner and outer circle as seen in FIG. 6 in area 601. This effect will keep the aesthetic features of keyboard 401, while further eliminating user misstrokes. The letters can be arranged as seen in 401 or can be arranged in any fashion by the user. The user can change the number of letters in the inner and outer circle, change the shape the keys, change the overall layout of the keys to shape other than circular, and change the letters assigned to each virtual button.

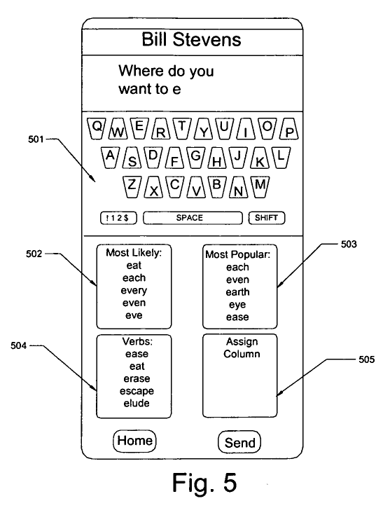

An exemplary embodiment of the invention is a cellular phone with a virtual keyboard as depicted as 501 in FIG. 5. This virtual keyboard is arranged in the customary linear fashion as in keyboard 201 and the buttons are arranged in the alternating shapes in a similar fashion as keyboard 401 but adapted for a linear letter arrangement. Keyboard 501 can optionally contain extended letter boundaries beyond the graphical depiction of keyboard 401 similar to that as depicted in 602 so that the effect of the alternating shapes can be maximized while maintaining the same aesthetic representation of keyboard 501. For example, in Keyboard 602, the letter W can be inputted even if the user touches outside the shape of button, as long as the user touches within the outer border 603. Such a design aims to maximize the effect of the keyboard design, while maintaining the look of keyboard 401. Keyboard 501 can be customized to change the number of letters in the inner and outer circle, change the shape the keys, change the overall layout of the keys to shape other than circular, and change the letters assigned to each virtual button.

Further stored in memory of the cellular phone are rules for improving efficiency in text messages. These rules include the comparison techniques utilized by the cellular phone to determine the user's intended word. These rules include those detailed above in the example of entering the words “CELL PHONE”, English rules, and as well as any custom rule the user may wish to define.

Also stored in the memory of the cellular phone is a list of words corresponding to possible words that begin with the letters that the user has already entered in previous messages. These words are displayed in columns from which the user can select a word. The columns can be customized to include words as specified by the user, and can be arranged in any order that the user finds preferable. As seen in FIG. 5, the first column, 502, includes the most likely intended words based on the current letters of the current word as well as previous words, both being analyzed by the rules in the memory. The second column, 503, includes the most popular words starting with the currently inputted letters. The third column, 504, is determined by the rules stored on memory which determines the most likely part of speech that would classify the intended word. For example, in this case the rules have determined that a verb is most likely to occur next and thus the column will include all verbs starting with currently inputted letters. The fourth column, 505, has not yet been assigned and is currently open to assignment by the user. The user can use any of the stored rules, parts of speech, or any other customized rules to fill the column 505.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

In addition, while a particular feature of the invention may have been disclosed with respect to only one of several embodiments, such feature may be combined with one or more other features of the other embodiments as may be desired. Additionally, specific details may have been omitted inasmuch as such details are not considered necessary to obtain a complete understanding of the present invention, and are considered to be within the understanding of persons of ordinary skill in the relevant art.

It is therefore contemplated that the claims will cover any such modifications or embodiments that fall within the true scope of the invention.

What is claimed is:

1. A device comprising:
an input device including a plurality of buttons;
said plurality of buttons designed in a manner to decrease user input error, wherein said plurality of buttons differ or alternately differ in shape to reduce user input error.

2. The device of claim 1, wherein said input device is a keyboard, a touch-screen keyboard, or a virtual input device.

3. The device claim 1 wherein the shape or the alignment of the plurality of buttons are designed to reduce user input error.

4. The device claim 2 wherein the shape or the alignment of the plurality of buttons are designed to reduce user input error.

5. The device of claim 1 wherein the shape of a first button of said plurality of buttons differs from the shape of a second button of said plurality of buttons, and the shapes of such said first and second buttons repeated in the shapes of other of said plurality of buttons.

6. The device of claim 2 wherein the shape of a first button of said plurality of buttons differs from the shape of a second button of said plurality of buttons, and the shapes of such said first and second buttons repeated in the shapes of other of said plurality of buttons.

7. The device of claim 1 wherein the upper section of a first button of said plurality of buttons contains more area than the lower section of said first button and wherein the upper section of a second button of said plurality of buttons contains less area than the lower section of said one button, and such said first and second buttons are repeated in the shapes of other of said plurality of buttons.

8. The device of claim 2 wherein the upper section of a first button of said plurality of buttons contains more area than the lower section of said first button and wherein the upper section of a second button of said plurality of buttons contains less area than the lower section of said one button, and such said first and second buttons are repeated in the shapes of other of said plurality of buttons.

9. The device of claim 2 wherein one or more of said plurality of buttons are associated with one or more corresponding areas, wherein each of said one or more corresponding areas represents an area in which a button may be pressed.

10. The device of claim 9 wherein said one or more corresponding areas differs in area from the physical representation of the button.

11. The device of claim 1 further including a memory, said memory storing rules to predict intended user input based on input surrounding an inputted word.

12. The device of claim 2 further including a memory, said memory storing rules to predict intended user input based on input surrounding an inputted word.

13. The device of claim 6 further including a memory, said memory storing rules to predict intended user input based on input surrounding an inputted word.

14. The device of claim 1 wherein said rules include one or more of user popularity, user defined rules, language, or common combinations of words.

15. The device of claim 2 wherein said rules include one or more of user popularity, user defined rules, language, or common combinations of words.

16. The device of claim 6 wherein said rules include one or more of user popularity, user defined rules, language, or common combinations of words.

17. The device of claim 14 wherein the results obtained from applying said rules to a user's input are displayed on said display on the device for selection as input by the user.

18. The device of claim 15 wherein the results obtained from applying said rules to a user's input are displayed on said display on the device for selection as input by the user.

19. The device of claim 16 wherein the results obtained from applying said rules to a user's input are displayed on said display on the device for selection as input by the user.

20. The device of claim 14 wherein said rules are applied in combination to determine a user's intended input.

21. The device of claim 15 wherein said rules are applied in combination to determine a user's intended input.

22. The device of claim 16 wherein said rules are applied in combination to determine a user's intended input.

23. A device comprising:
a plurality of buttons;
a memory;
rules for predicting intended user input applied by said device;
said rules comprising at least one of language, user popularity, or user defined rules, or words used commonly in combination;
said rules applied to analyze current input in the context of previous input; and
said analysis predicting a user's intended input to complete an incomplete input.

24. The device of claim 23 wherein the results of said analysis are displayed on a display for selection by the user.

25. The device of claim 23 wherein the results of said analysis are automatically applied as the user's intended input.

26. The device of claim 23 wherein said plurality of buttons are designed to decrease user input error.

27. The device of claim 23 wherein said plurality of buttons are designed so that the shape or the alignment of each button reduces user input error.

28. The device of claim 23 wherein said plurality of buttons differ in shape so that user input error is reduced.

29. The device of claim 23 wherein the shape of a first button of said plurality of buttons differs from the shape of a second button of said plurality of buttons, and wherein the shapes of such said first and second buttons and are repeated in the shapes of other of said plurality of buttons and aligned to reduce user input error.

30. An input device comprising:
buttons arranged in a pattern;
the pattern containing two differing and repeating button shapes;
the first button with a shape with the upper border substantially longer than the lower border;
the second button with a shape with the lower border substantially longer than the upper border; and
the pattern alternately repeating to complete the buttons an input device.
